(19) United States
(12) Patent Application Publication
(10) Pub. No.: US 2008/0178136 A1
(43) Pub. Date: Jul. 24, 2008

(54) Method, Apparatus, and Computer Program Product for Implementing Balanced Wiring Delay Within an Electronic Package

(76) Inventors: Gerald Keith Bartley, Rochester, MN (US); Darryl John Becker, Rochester, MN (US); Paul Eric Dahlen, Rochester, MN (US); Philip Raymond Germann, Oronoco, MN (US); Andrew Benson Maki, Rochester, MN (US); Mark Owen Maxson, Mantorville, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/625,906

(22) Filed: Jan. 23, 2007

(51) Int. Cl. G06F 17/50

(52) U.S. Cl. 716/13; 716/18

(57) ABSTRACT

Balanced wiring delay within an electronic package is implemented. A plurality of nets in a net group is identified in the electronic package. A predefined structure is added to each net within the group. A balanced wiring delay customizing program systematically processes and reduces length of the nets until a set length balance is obtained for the net group.

### FIELD OF THE INVENTION

The present invention relates generally to the data processing field, and more particularly, relates to a method, apparatus and computer program product for implementing balanced wiring delay within an electronic package.

### DESCRIPTION OF THE RELATED ART

Today the task of balancing delay through length matching of routing traces down to within a couple picoseconds in an electronic package is an extremely tedious process when done manually.

Typically auto-routing methods fail to achieve such tight timing constraints if initial planning has not been factored into the routing strategy. Autorouters may not follow stringent electrical design constraints or may not perform the exact same method on multiple iterations. The other known solutions today are multiple iterations of manual routing using length constraints to guide the person performing the physical design. There are numerous “autorouter” techniques and patents pertaining to printed circuit boards, and skew adjustments to on-chip skew, for example:

U.S. Pat. No. 6,256,769 issued Jul. 3, 2001 to Tamarkin et al., discloses apparatus and methods for defining circuit routing paths between electronic components on a substrate. A method includes associating one or more routing rules with connections between the components, wherein at least one of the routing rules is a minimum length routing rule; defining a first set of routing paths between the components while ignoring the minimum length routing rule; and modifying the first set of routing paths by enforcing the minimum length routing rule. Apparatus for defining circuit routing paths between components on a substrate includes a database and a routing engine that accepts the database as input. The database has an entry that includes a connection that is represented by a signal traveling between a start point and an end point on the substrate, and a set of routing rules associated with the connection. The set of routing rules includes at least a minimum length routing rule. The routing engine defines a first routing path from the start point to the end point that provides information necessary to establish the connection, while ignoring the minimum length routing rule associated with the connection. The routing engine then enforces the minimum length routing rule by increasing the length of the first routing path to define a modified routing path.

U.S. Pat. No. 6,862,727 issued Mar. 1, 2005 to Stevens, discloses a computer executable process for adjusting traces routed through a routing area of a depiction of an electronics system. The process includes receiving computer readable data comprising parameters defining the routing space, the traces, and obstacles within the routing space, each of the traces comprising a plurality of interconnected nodes; determining spacings between adjacent nodes of each trace, and adjusting a number of nodes in each trace based on the spacings; assigning forces to nodes of each trace based on a proximity of the nodes to objects within the routing area, the objects including at least one of an obstacle and other nodes; and moving the nodes in accordance with the forces.

U.S. Pat. No. 5,507,029 issued Apr. 9, 1996 to Granato et al., discloses a method for minimizing the time skew between signals traveling through various multi-cycle path nets linking one or several VLSI packages that includes a plurality of IC chips interconnected to each other. The method includes equalizing differences between the early and the late mode slack for each of the multi-cycle nets to decrease the joint probability of failure; maximizing the time balance between the early and the late mode slack; balancing over all the nets the difference between the early and the late mode slack, minimizing in the process statistical variations within the mode slack pair; and compensating for asymmetries between rising and falling switching times using the mode slack pair. The method allows multi-cycle path nets have their transmission line length confined between a maximum and a minimum length, which in turn minimizes the skew between signals in each of the nets, decreases cycle time and improves the overall performance of the system.

A need exists for an effective solution to automate the refinement portion of the routing in an electronic package, which will allow multiple iterations automatically when needed and provide a known electrically acceptable solution.

### SUMMARY OF THE INVENTION

A principal aspect of the present invention is to provide a method, apparatus and computer program product for implementing balanced wiring delay within an electronic package. Other important aspects of the present invention are to provide such a method, apparatus and computer program product for implementing balanced wiring delay within an electronic package substantially without negative effect and that overcome many of the disadvantages of prior art arrangements.

In brief, a method, apparatus and computer program product are provided for implementing balanced wiring delay within an electronic package. A plurality of nets in a net group is identified in the electronic package. A predefined structure is added to each net within the group. A balanced wiring delay customizing program systematically processes and reduces length of the nets until a set length balance is obtained for the net group.

In accordance with features of the invention, the electronic package is a build-up laminate or other similar chip carrier package, and the predefined structure is added to the nets in the net group on a selected layer below a core of the electronic package. The predefined structure includes a trace structure providing an appropriate electrical solution and incremental delay step.

In accordance with features of the invention, systematically processing and reducing length of the nets includes identifying a longest net within the net group, and incrementally reducing the structure length of the identified longest net until a minimum length is obtained. Then each of the remaining nets is systematically selected and processed by incrementally reducing the structure length of the selected net to provide a reduced length within a set range.

In accordance with features of the invention, the structure length of the remaining nets is reduced and balanced to within the desired range by stepping through each remaining net and modifying and minimizing its structure as needed.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating a computer system and operating system for carrying out methods for implementing balanced wiring delay within an electronic package in accordance with the preferred embodiment;

FIG. 2 is a flow chart illustrating exemplary steps for implementing balanced wiring delay within an electronic package in accordance with the preferred embodiment;

FIGS. 3, 4, 5, 6, 7, 8, 9, and 10 are exemplary structures illustrating exemplary steps for implementing balanced wiring delay within an electronic package in accordance with the preferred embodiment;

FIGS. 11A, 11B, 11C, and 11D are exemplary structures illustrating exemplary steps for implementing balanced wiring delay within an electronic package in accordance with the preferred embodiment;

FIG. 12 is a side view illustrating an exemplary electronic package common build-up laminate including build-up layers above and below a core steps for implementing balanced wiring delay within the electronic package in accordance with the preferred embodiment; and

FIG. 13 is a block diagram illustrating a computer program product in accordance with the preferred embodiment.

### DETAILED DESCRIPTION OF THE PREFERRED EMBODIMENTS

In accordance with features of the preferred embodiment, a structure in the electronic package is provided that can be modified by a computer program to refine the routing delay in an electronic package, and specifically in a build-up laminate or other similar chip carrier packages. A basic structure includes a predefined structure including a plurality of line segments having a set pattern added on all nets within a group of nets to be balanced on one or more layers generally used for via jog routing. The method of the invention then systematically steps through and reduces the lengths of these jogs until a tight length balance is obtained for the group of nets being routed. The structures are predefined to provide an appropriate electrical solution and incremental delay step. Multiple iterations can be rerun starting with the same structure as many times as needed.

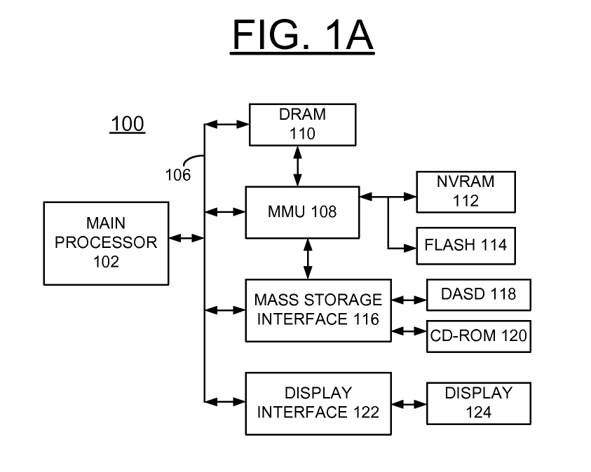

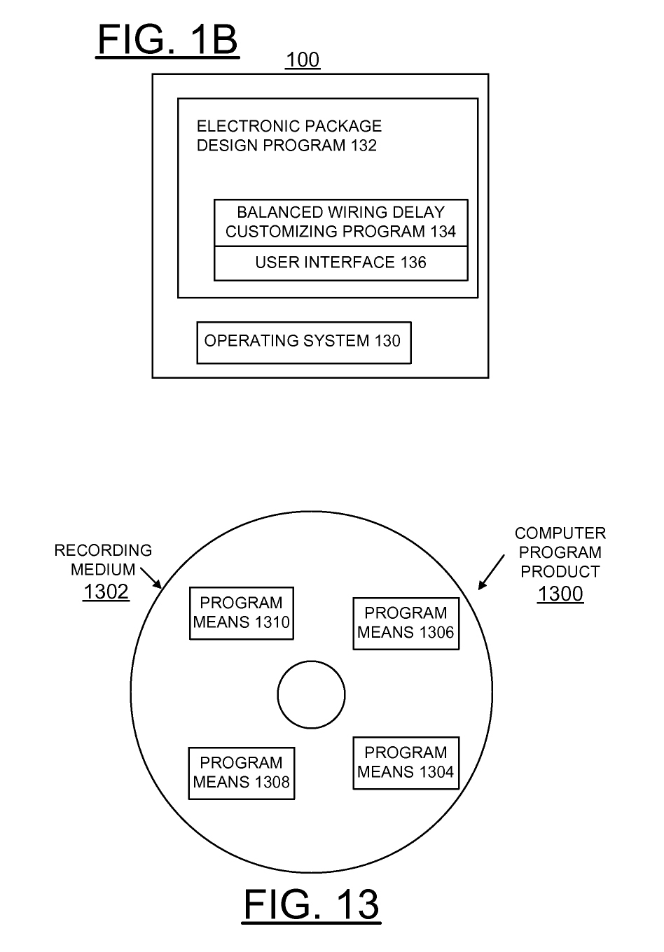

Referring now to the drawings, in FIGS. 1A and 1B there is shown a computer system generally designated by the reference character 100 for implementing balanced wiring delay within an electronic package in accordance with the preferred embodiment. Computer system 100 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. Computer system 100 includes a display interface 122 coupled to the system bus 106 and connected to a display 124.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, multiple main processors.

As shown in FIG. 1B, computer system 100 includes an operating system 130, an electronic package design program 132, a balanced wiring delay customizing program 134 of the preferred embodiment, and a user interface 136.

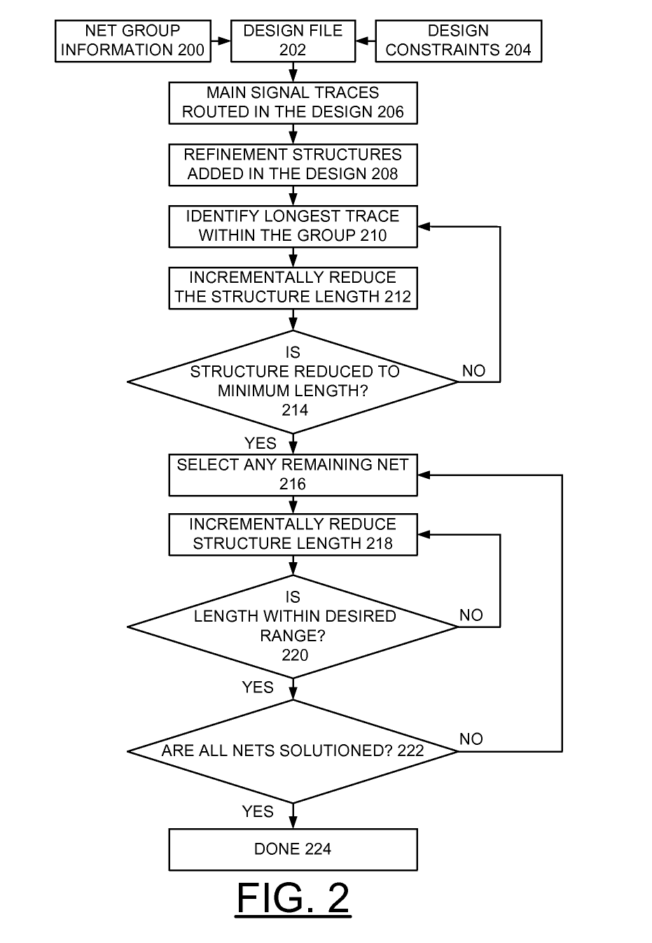

Various commercially available computers can be used for computer system 100, for example, an IBM personal computer. CPU 102 is suitably programmed by the balanced wiring delay customizing program 134 to execute the flowchart of FIG. 2 for implementing balanced wiring delay within an electronic package in accordance with the preferred embodiment.

Referring now to FIG. 2, there are shown exemplary steps for implementing balanced wiring delay within an electronic package in accordance with the preferred embodiment. Net group information identified at a block 200 is applied to a design file that includes electronic package physical design data as indicated at a block 202. Design constraints identified at a block 204 are applied to the design file at block 202. The design file is processed and the main signal traces routed in the design are identified by the balanced wiring delay customizing program 134 as indicated at a block 206.

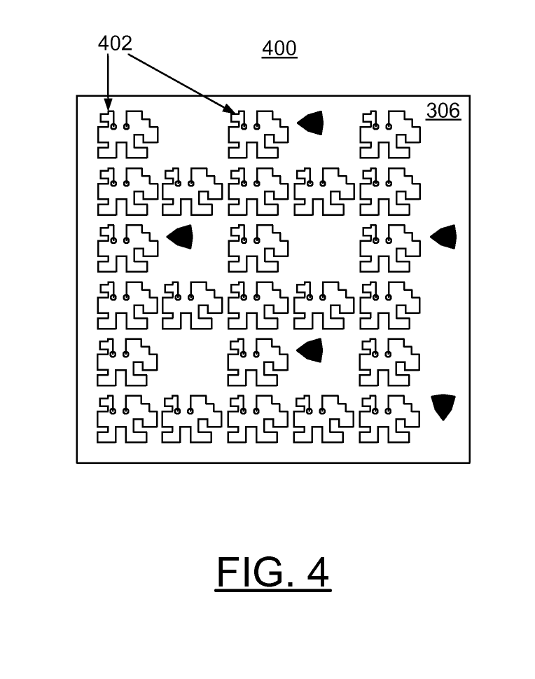

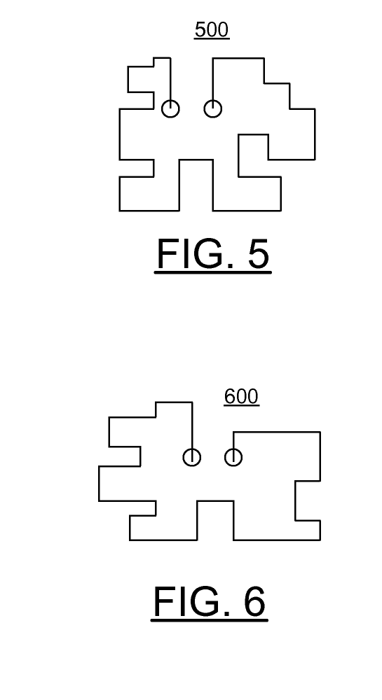

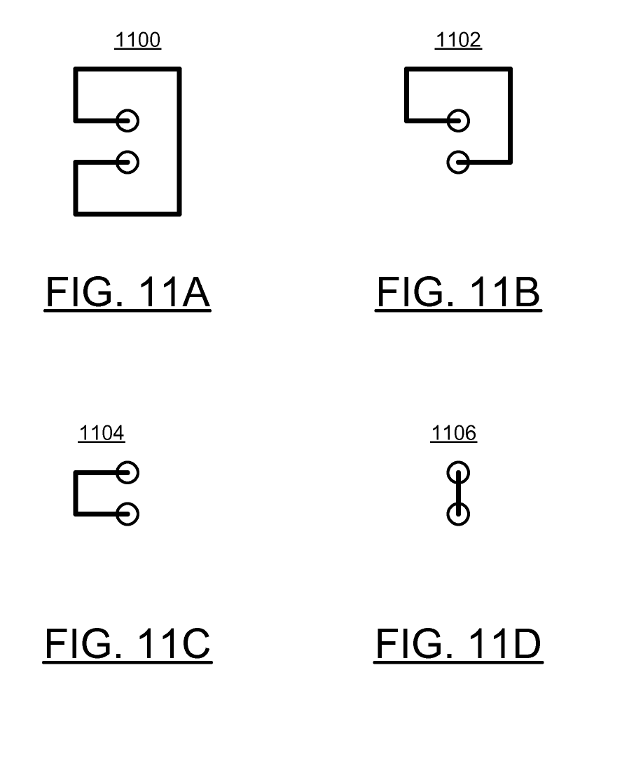

Next refinement structures are added to each of the nets within the net group identified as indicated at a block 208. The refinement structure can be implemented by one of various predefined patterns, such as, illustrated in FIGS. 4, and 5, or FIG. 11A. Next a longest trace within the net group is identified as indicated at a block 210. Then the structure length is incrementally reduced as indicated at a block 212. Checking for the structure being reduced to a minimum length is performed as indicated at a decision block 214. When the structure has been reduced to the minimum length, then any remaining net in the net group is selected as indicated at a block 216. Then the structure length is incrementally reduced as indicated at a block 218. Checking for the structure being reduced to a length within a desired range is performed as indicated at a decision block 220. When the structure has been reduced to a length within the desired range, then checking whether all nets in the net group have been solutioned or processed is performed as indicated at a decision block 222. When a remaining net to be processed is identified, then the operations return to block 216 to select a remaining net in the net group to be processed. When all nets have been processed, then the sequential operation end as indicated at a block 224.

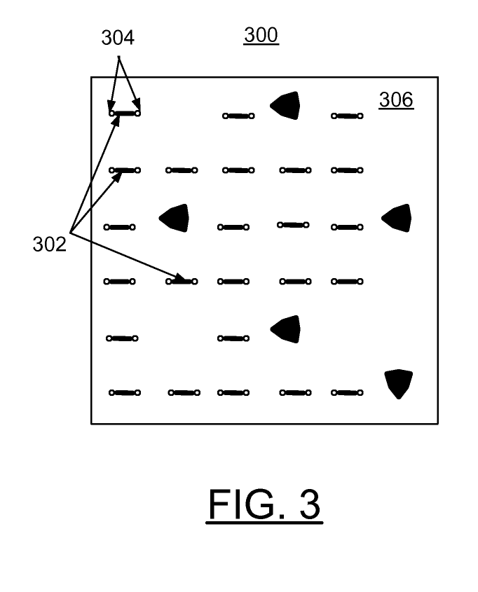

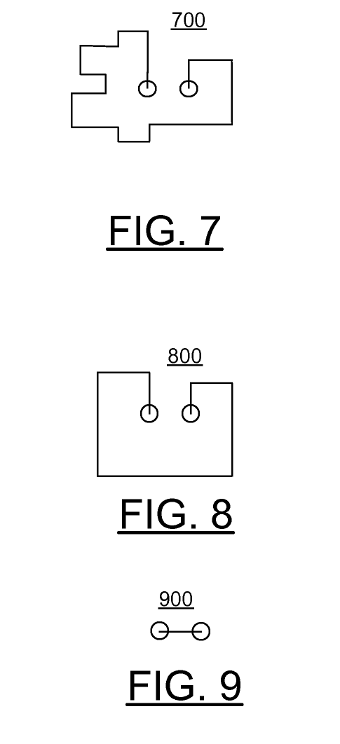

FIGS. 3, 4, 5, 6, 7, 8, 9, and 10 are exemplary structures illustrating exemplary steps for implementing balanced wiring delay within an electronic package in accordance with the preferred embodiment.

FIG. 3 shows a typical structure generally designated by the reference character 300 including a group of nets 302 with via jogs 304, disposed on a layer 306 beneath the core in an electronic package build-up laminate design. The primary routing of the traces are typically routed on one of the layers above the core in a build-up laminate structure. The layer shown in FIG. 3 typically has minimal via jogs, for example, in lower a build-up layer to avoid via stacking.

FIG. 4 shows an example structure 400 of this layer 306 with a respective beginning adjustable delay trace 402 initially added to respective nets 302 to allow length balancing refinement in accordance with the preferred embodiment. FIG. 4 shows segmented patterned trace structures 402 provided on each of the nets within that group 300. It should be understood that there are many variations of structures, which could be used depending on the amount and precision of the balancing needed. Also it should be understood that adjustable structures advantageously are added to more than one plane in the design.

FIGS. 5, 6, 7, 8, and 9 show exemplary respective structures 500, 600, 700, 800, and 900 illustrating systematic reduction of the trace length beginning with a longest structure 500, sequential respective reduced length traces 600, 700, 800 and that reduces to a minimum length structure 900.

As shown in FIG. 5, the longest initial structure 500 corresponds to the beginning adjustable delay trace 402 initially added to respective nets 302, however, it should be understood that various other initial shaped delay traces may be used. Once one of the nets 302 is reduced to the minimum adjustable delay trace 900, then the remainder of the initial traces 402 are balanced to within the desired range by modifying the initial predefined structure 500 as needed. The number of increments available depends upon the precision of the balancing needed. For example, the illustrated particular example starts with an initial length of 4 mm, which can be reduced to 0.15 mm in five incremental steps allowing a refined delay variation of up to 27 psec.

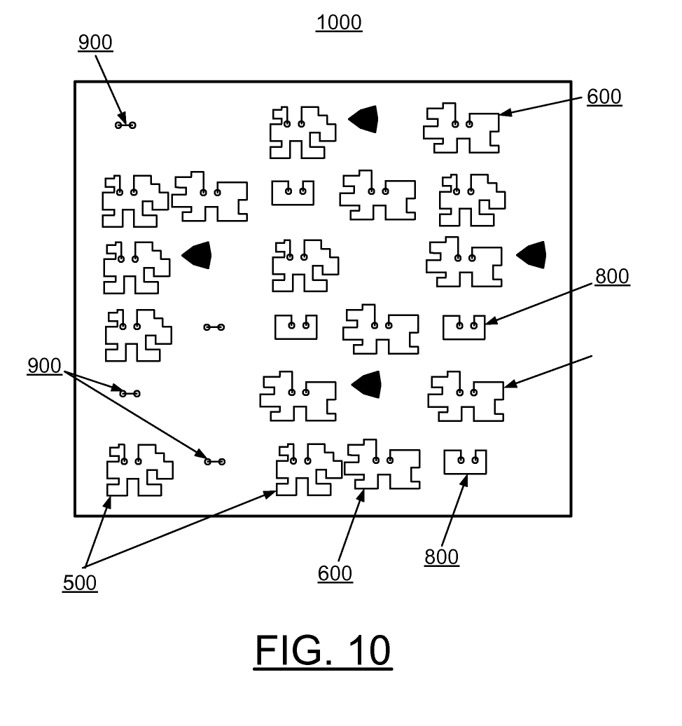

FIG. 10 illustrates an exemplary structure generally designated by the reference character 1000 showing how the same area 400 can appear after the adjustments have been made to respective signal delay traces 402 within that illustrated group 300. As shown, multiple different delay traces 500, 600, 800 and 900 are provided in the exemplary structure 1000.

FIGS. 11A, 11B, 11C, and 11D provide a plurality of exemplary respective structures 1100, 1102, 1104, and 1106 illustrating exemplary steps for implementing balanced wiring delay within an electronic package in accordance with the preferred embodiment. This method of the preferred embodiment advantageously is applied to multiple layers in the design using a more simplified structure on each layer. For example, the method can be implemented using a more simplified structure on each layer as shown in FIGS. 11A, 11B, 11C, and 11D. The adjustments are made on multiple layers with at least one of the traces in the group having a minimum path, shown in step 4, of FIG. 11D on all the layers with these structures.

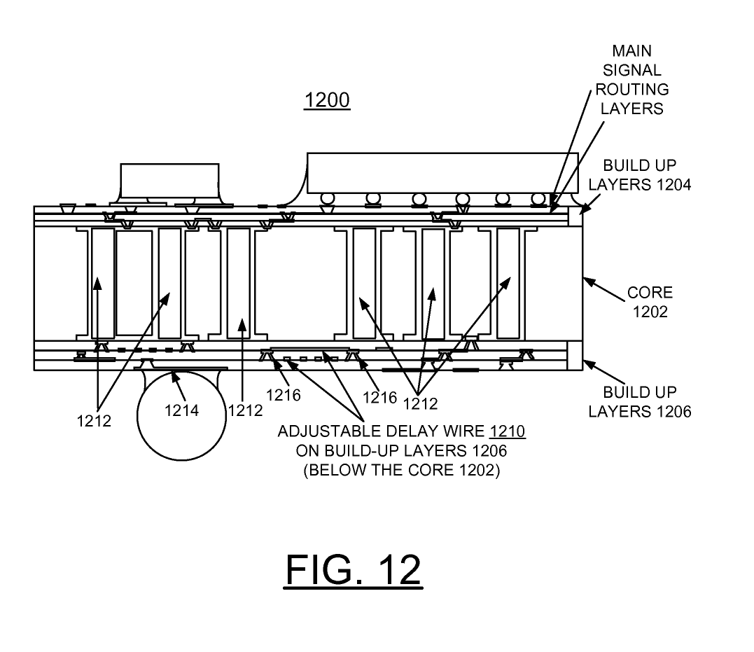

FIG. 12 is a side view illustrating an exemplary electronic package common build-up laminate generally designated by the reference character 1200 including a core 1202. Above and below the core 1202, there is a plurality of respective build-up layers 1204, 1206. The respective build-up layers 1206 beneath the core 1202 advantageously are used for implementing balanced wiring delay within the electronic package 1200 in accordance with the preferred embodiment. The build-up layers 1206 advantageously include adjustable delay wire structures 1210.

A conventional or typical wiring strategy in this type of package 1200 includes most of the main signal trace routing, and possibly some balancing, in the build-up layers 1204 above the core 1202. The signal then drops through the core 1202 with one of a plurality of large PTH vias 1212, for example, very near a corresponding, assigned BGA pad 1214.

In accordance with features of the invention, staggered or offset micro-vias 1216 are used with the adjustable delay wire structures 1210 within the build-up layers 1206 beneath the core 1202 for implementing balanced wiring delay within an electronic package. The present invention generally can avoid the need for stacked vias, or a via on top of another via, which may create manufacturing problems.

While the build-up layers 1206 beneath the core 1202 are illustrated for implementing balanced wiring delay within an electronic package, it should be understood that another selected layer or layers in the electronic package could be used for implementing balanced wiring delay in accordance with features of the invention. It should be understood that the method of the invention can be implemented with various types of electronic packages that have routing space available, such as ceramic, while the basic wiring strategy of this method is easily applied to build-up laminate packages.

Referring now to FIG. 13, an article of manufacture or a computer program product 1300 of the invention is illustrated. The computer program product 1300 includes a recording medium 1302, such as, a floppy disk, a high capacity read only memory in the form of an optically read compact disk or CD-ROM, a tape, or another similar computer program product. Recording medium 1302 stores program means 1304, 1306, 1308, 1310 on the medium 1302 for carrying out the methods for implementing balanced wiring delay within an electronic package of the preferred embodiment in the system 100 of FIGS. 1A and 1B.

A sequence of program instructions or a logical assembly of one or more interrelated modules defined by the recorded program means 1304, 1306, 1308, 1310, direct the computer system 100 for carrying out methods for implementing balanced wiring delay within an electronic package of the preferred embodiment.

While the present invention has been described with reference to the details of the embodiments of the invention shown in the drawing, these details are not intended to limit the scope of the invention as claimed in the appended claims.

What is claimed is:

1. A method for implementing balanced wiring delay within an electronic package comprising the steps of:
receiving a design file for the electronic package;
identifying a plurality of nets in a net group in the electronic package;
adding a predefined structure to each of said plurality of nets in said net group; and
systematically processing and reducing a length of said plurality of nets in said net group until a set length balance is obtained for said net group.

2. The method for implementing balanced wiring delay as recited in claim 1 wherein the step of receiving said design file for the electronic package includes receiving net group information for the electronic package.

3. The method for implementing balanced wiring delay as recited in claim 1 wherein the step of receiving said design file for the electronic package includes receiving predefined design constraints for the electronic package.

4. The method for implementing balanced wiring delay as recited in claim 1 wherein the step of identifying a plurality of nets in a net group in the electronic package includes identifying a plurality of main signal traces routed in said design file.

5. The method for implementing balanced wiring delay as recited in claim 1 wherein said predefined structure includes a trace structure providing an appropriate electrical solution and incremental delay step.

6. The method for implementing balanced wiring delay as recited in claim 1 wherein the electronic package includes one of a build-up laminate and a chip carrier package, and wherein the step of adding said predefined structure includes adding said predefined structure to each of said plurality of nets in said net group on a selected layer below a core of the electronic package.

7. The method for implementing balanced wiring delay as recited in claim 1 wherein the step of systematically processing and reducing a length of said plurality of nets in said net group includes identifying a longest net within the net group, and incrementally reducing a structure length of said identified longest net until a minimum length is obtained.

8. The method for implementing balanced wiring delay as recited in claim 7 further includes the steps of systematically selecting and processing each remaining net of said plurality of nets.

9. The method for implementing balanced wiring delay as recited in claim 8 wherein the step of systematically selecting and processing each said remaining net includes incrementally reducing a structure length of each selected remaining net to provide a reduced length within a set range.

10. The method for implementing balanced wiring delay as recited in claim 8 wherein the step of systematically selecting and processing each of said remaining nets includes modifying and minimizing said added structure of each of said remaining nets.

11. The method for implementing balanced wiring delay as recited in claim 1 wherein the step of adding said predefined structure to each of said plurality of nets in said net group includes providing said predefined structure having a plurality of line segments connected between a pair of via jogs.

12. A computer program product for implementing balanced wiring delay within an electronic package in a computer system, said computer program product including instructions stored on a computer readable storage medium, wherein said instructions, when executed by the computer system to cause the computer system to perform the steps of:
receiving a design file for the electronic package;
identifying a plurality of nets in a net group in the electronic package;
adding a predefined structure to each of said plurality of nets in said net group; and
systematically processing and reducing a length of said plurality of nets in said net group until a set length balance is obtained for said net group.

13. The computer program product for implementing balanced wiring delay as recited in claim 12 wherein the step of receiving said design file for the electronic package includes receiving net group information for the electronic package.

14. The computer program product for implementing balanced wiring delay as recited in claim 12 wherein the step of identifying a plurality of nets in a net group in the electronic package includes identifying a plurality of main signal traces routed in said design file.

15. The computer program product for implementing balanced wiring delay as recited in claim 12 wherein the step of systematically processing and reducing a length of said plurality of nets in said net group includes identifying a longest net within the net group, and incrementally reducing a structure length of said identified longest net until a minimum length is obtained.

16. The computer program product for implementing balanced wiring delay as recited in claim 15 further includes the steps of systematically selecting and processing each remaining net of said plurality of nets.

17. The computer program product for implementing balanced wiring delay as recited in claim 16 wherein the steps of systematically selecting and processing each remaining net of said plurality of net includes incrementally reducing a structure length of each selected remaining net to provide a reduced length within a set range.

18. The computer program product for implementing balanced wiring delay as recited in claim 16 wherein the steps of systematically selecting and processing each remaining net of said plurality of nets includes modifying and minimizing said added structure of each of said remaining nets.

19. An apparatus for implementing balanced wiring delay within an electronic package comprising:
a computer system; said computer system including a central processor unit (CPU) and a memory storing a balanced wiring delay customizing program and a design file for the electronic package;
said CPU being programmed by said balanced wiring delay customizing program to perform the steps of:
receiving said design file for the electronic package;
identifying a plurality of nets in a net group in the electronic package;
adding a predefined structure to each of said plurality of nets in said net group; and
systematically processing and reducing a length of said plurality of nets in said net group until a set length balance is obtained for said net group.

20. The apparatus for implementing balanced wiring delay as recited in claim 19 wherein said design file for the electronic package includes predefined design constraints for the electronic package and net group information.
